(19) United States
(12) Patent Application Publication
(10) Pub. No.: US 2003/0056425 A1
(43) Pub. Date: Mar. 27, 2003

(54) Barbless fishing hook

(76) Inventors: James K. Ivarson, Calgary (CA); Michael Boudreau, Salmon Arm (CA)

Correspondence Address: ANTONY C. EDWARDS, SUITE 800, 1708 DOLPHIN AVENUE, KELOWNA, BC, V1Y 9S4, CA

(21) Appl. No.: 10/146,071

(22) Filed: May 16, 2002

Related U.S. Application Data
(63) Continuation of application No. 09/594,222, filed on Jun. 14, 2000, now abandoned.
Application No. 09/594,222 is a continuation-in-part of application No. 09/134,066, filed on Aug. 13, 1998, now abandoned.
Application No. 09/134,066 is a continuation-in-part of application No. 08/702,243, filed on Aug. 27, 1996, now abandoned.
(60) Provisional application No. 60/005,350, filed on Oct. 18, 1995.

(51) Int. Cl. A01K 83/00

(52) U.S. Cl. 43/43.16

(57) ABSTRACT

The barbless fishing hook has a shank having a longitudinal axis and a spike at one end, and extending longitudinally along the shank adjacent to the spike, a radially expanded surface extending radially outwardly of the longitudinal axis so as to define, in a first plane perpendicular to the longitudinal axis, a smoothly rounded generally radial arc devoid of stress concentration causing corners or elongate protrusions and so as to define, in a second plane containing the longitudinal axis, along the intersection of the second plane with the radially expanded surface, a line of intersection smoothly blending the radially expanded surface with the spike at one end of the line of intersection and with the shank at an opposed end of the line of intersection and the distance between the line of intersection and the longitudinal axis, perpendicular to the longitudinal axis, increasing smoothly along the shank from the spike to a maximum radial distance where the smoothly rounded generally radial arc sweeps out a maximum area in the first plane.

### CROSS REFERENCE TO RELATED APPLICATION

This application is a Continuation of United States Continuation-in-Part patent application Ser. No. 09/594,222 filed Jun. 14, 2000 which is a Continuation-in-Part of United States Continuation-in-Part patent application Ser. No. 09/134,066 filed Aug. 13, 1998 which is a Continuation-in-Part from U.S. patent application Ser. No. 08/702,243 filed Aug. 27, 1996 which claims priority from U.S. Provisional Patent Application No. 60/005,350 filed Oct. 18, 1995.

### FIELD OF THE INVENTION

This invention relates to the field of fishing hooks, and in particular to barbless fishing hooks.

### BACKGROUND OF THE INVENTION

Presently, in many parts of the world, sport fishing regulations are demanding so-called “catch and release” fishing. This means that fish caught with conventional barbed hooks such as depicted in FIG. 1 may be repeatedly wounded by tearing of the skin and flesh, usually in the vicinity of the fish's mouth, every time the fish is caught and released. Often, as lakes are stocked with smaller fish, such catch and release of small fish, when they have been caught using a barbed hook, results in the death of the fish.

Consequently, regulations are now being put into place requiring catch and release fishing to be done with barbless hooks.

The barbless hooks presently being used are, as depicted in FIG. 2, hooks which merely come to a point in the manner of a spike. It has been found that a drawback of such barbless hooks is a “stiletto” effect in that while a fish is fighting the hook, if the hook is a barbless hook, the hook repeatedly releases within the mouth of the fish and then re-penetrates the fish in a different position. The stiletto effect thus often results in repeated wounding of the fish which is of course contrary to the intention behind using a barbless hook.

Attempts in the prior art at creating useful and effective barbless hooks appear to have overlooked two fundamental physical properties of the fish during the three phases of the acquisition and release of the fish. The three phases may be summarized as:

(a) the strike phase in which the target fish, having been attracted by the bait, bites at the bait thereby taking the hook into its mouth,

(b) the fight phase in which the hook is set in the fish's mouth by the penetration of the spike (and the penetration of the barb if a conventional fishing hook) into the flesh and tissue of the fish's mouth and by the reaction of the fish in fighting to dislodge the spike from the wound, including the reeling-in and capture of the fish,

(c) the release phase in which the fish is held and the fishing hook manually removed by forcing the spike backwards through the penetration wound.

During all three phases it is desirable, in order to minimize damage to the fish, to minimize tearing or cutting of the flesh during the strike, to retain the spike in place once set following the strike, and to retain the spike in place and minimize sawing and cutting of the flesh during the ensuing fight, reeling-in and capture of the fish, and to minimize the tearing or cutting of the flesh during removal of the spike prior to the release of the fish. In order to accomplish this it must be kept in mind that the flesh and tissue of the fish, in the mouth region in particular, have certain mechanical properties which, depending on the design of the fishing hook, will determine whether a single clean puncture wound is accomplished, or whether the result is tearing, cutting or sawing of the initial puncture wound. The primary mechanical properties are the elasticity and the strength of the flesh and tissue, governed in part by the stress and strain properties of the flesh and tissue material.

Referring to soft tissue generally, living soft tissues are generally non-linearly elastic and somewhat stress-history dependent. Generally speaking, biological solids such as the flesh and tissue of a fish's mouth are multiphase, non-homogeneous and anisotropic. Such is the case within a fish's mouth where a fish hook may set in virtually any location and orientation. However, if generalizing assumptions are made about the average aggregate stress and strain properties of the fish's mouth, then it may be seen that prior art designs, if it were their object to minimize damage to a fish, were ineffective. Those generalized assumptions may be made based on a typical connective tissue in an animal. For example, studies have been conducted of the rabbit mesentery, the thin membrane that connects the intestines. In simple tensile testing the mesentery exhibits a non-linear, exponential load versus extension relationship indicative of the stress-strain relationship, that is, there was small stress in response to fairly large strain up to a point, after which the stress increased rapidly in response to a small further strain. The data once reduced to the Lagrangian stress (the force divided by the relaxed cross sectional area) and the extension ratio (of the deformed length divided by the relaxed length), revealed, when the rate of change of the Lagrangian stress relative to the extension ratio was plotted against the elastic tension, that the resulting plot was linear for relatively low extension ratios not exceeding 2.5 for mesentery and 2 for skin and muscles (Y. C. Fung, “Elasticity of Soft Tissues in Simple Elongation” American Journal of Physiology, 213, 6 (1967) 1532-1544).

Consequently, for soft tissue, in that it would appear that such exponential type of material is natural in the biological world, where the sample is not elongated to more than double its relaxed length, relatively small stress will result, minimizing the risk of failure of the tissue (i.e. tearing) and increasing the probability of a nearly perfectly elastic hysteresis. The mesentery study indicated nearly perfectly elastic hysteresis, although hysteresis did exist, and that hysteresis was not affected greater by strain rate (although not the strain rate likely encountered by fish tissue during the strike phase). Extending this result then to a circular penetration wound in soft tissue, assuming the stress concentration around the puncture hole is approximately evenly distributed, and assuming the mesentery study is indicative of the elastic properties of the soft tissue of a fish's mouth, even given greater strain rates during the strike phase, then for puncture holes where the circumference remains small, stress will not build-up excessively, i.e. so as not to cause failure of the soft tissue under the circumferential loading, as the puncture hole opens to admit the cylindrical spike of the fishing hook.

It is also known that a very slender hole or slot (i.e. where the length to width ratio of the hole is large) elongated perpendicular to the direction of simple tensile forces causes a very high stress concentration at the ends of the elongated hole, thus resulting in cracking or tearing transversely to the tensile force (Timoshenko and Goodier, Theory of Elasticity, 3rd Ed. (1970), McGraw-Hill, New York). By analogy then, a barb or like sharply pointed projection extending outwardly from the shaft of the fishing hook adjacent the spike of the fishing hook elongates the puncture hole in the soft tissue as the barb or projection is forced through the tissue. Although obviously more complex than simple tensile loading on the puncture hole, it is fair to assume a stress concentration around the puncture hole at the locus of elongation occurs when the locus of greatest elongation is a very narrow region or point, thereby increasing the likelihood of tearing or actual cutting of the soft tissue by the barb or projection in the strike phase exacerbated by the magnitude of the strain rate, and increasing the likelihood of tearing and cutting because of a sawing action of the barb or projection moving in and out of the puncture hole during the fight phase.

Thus in the prior art exemplified by the teaching of Keightley in U.K. patent application No. GB2,267,423, discussed in more detail below, a spade-shaped or spearhead-shaped flange which is generally symmetric on either side of the long axis of the spike end of the hook causes extensive elongation of the puncture hole, and consequently substantially increases the likelihood of tearing due to the stress concentrations at the distal ends of the elongated puncture hole.

In U.S. Pat. No. 2,841,914 which issued to Butler on Jul. 8, 1958, for Fish Hooks, what is taught is a barbless fish hook where the barb is replaced by a projection which has a point or transverse ridge of very small length defined by the intersection of two adjacent concave surfaces blending with the return arm. These surfaces, it would appear, may be formed by, for example, filing down the barb of a conventional barbed fish hook. The resulting point or transverse ridge, relied on to form a bulge on the return arm to thereby keep a fish on the hook, would, if the projection was actually large enough to keep a fish on the hook without the stiletto effect during the fight phase, result in stress concentrations causing the soft tissue of the fish's mouth to tear or be cut.

In the release phase, it is fair to say that a lot, if not most, anglers are inept at holding a struggling fish still with one hand so as to gently remove a hook, be it barbed or not, from a fish's mouth using pliers or the like so as not to tear or cut the soft tissue of the mouth. A simple single grasp and pull movement is all that can reasonably be expected of anglers. Such a motion to remove a barbed hook set in a fish's mouth inevitably causes tear damage.

Such a motion to remove the barbless hook of Butler would pull the sharp point or ridge of the fish retaining projection across the soft tissue so as to cut the soft tissue, especially if the projection was actually large enough to keep a fish on the hook during the fight phase. Such a motion to remove the Fishing Hook with Curved Barb of Levin, which issued as U.S. Pat. No. 5,386,660 on Feb. 7, 1995, would also be difficult without tearing the soft tissue because the Levin barb, illustrated in FIGS. 8 and 8a, is undercut behind the barb, thereby undesirably increasing the strain rate on the soft tissue as the tissue has to travel and expand around the increased distance and reversed direction to that in which the soft tissue is being pulled in order to clear the curved barb. This increases the likelihood of tearing.

In the Levin hook, the cross section of the return portion at the barb is flat-sided and has a blunt ridge with pronounced corners between the ridge and sides, and so, as with the Butler device, the projection of the barb must be significant in order to effectively set the hook, i.e. in order to have sufficient volume in the barb so that it sets the hook. This results in a significantly elongated puncture hole when the soft tissue is under its greatest stress, that is, at the point where the puncture hole is most elongated so as to cause a stress concentration at the elongated end, and in particular at the corners between the ridge and the sides of the barb. Again, this increases the likelihood of tearing of the soft tissue upon removal of the hook from the soft tissue.

Keightley describes a fishing hook having a shank terminating in a point which is contoured to include a diverging tip section which merges smoothly into a converging section which in turn merges smoothly into the shank of the hook. It is taught that the point may be formed symmetrically about a straight line defining an extension of the longitudinal axis of the end of the shank adjoining the point or that alternatively the point may be formed symmetrically about a curved line which defines an extension of the longitudinal axis of the end of the shank adjoining the point. Notwithstanding that Keightley states that other shapes of hooks can be adopted and that the important feature of all such hooks is the absence of a barb, what Keightley neither teaches nor suggests, and which it is an object of the present invention to provide, is a barbless hook having a fin or bulge formed generally as a teardrop-shaped convexity which is asymmetrical rather than spade-shaped relative to a longitudinal axis of the end of the shank adjoining the point.

U.S. Pat. No. 5,526,603 which issued to Fujii et al on Jun. 18, 1996, teaches a triangular barb, as illustrated in FIGS. 9 and 9a herein, having, inter alia, a formed sharp edge extended between the hook tip and a rear face of the barb. The rear face of the barb, formed between the tip of the barb and the base end of the rear face, is inclined at a large angle with respect to the fishhook body. A part of the upper surface of the tip portion is pressed with a first press to form a thin raised portion for barb formation, as illustrated in FIGS. 10 and 10a (corresponding to Fujii FIG. 21(b)), and FIGS. 11 and 11a (corresponding to Fujii FIG. 21(c)). The thin raised portion is arcuately raised from the surface of the tip portion. Subsequently, during formation of the barb, the rear portion of the thin raised portion for barb formation is chipped by means of a second press to form a curved rear face (Fujii FIGS. 21(d) and (e)). The curved rear face is disclosed to be a concave face curved so as to form an undercut beneath the formed sharp edge. The barb so formed is different from conventional barbs in that it does not form a long spike. Fujii states that since their fishhooks have a barb of unique shape, the barb is not easily broken so that even an inexperienced fisherman can easily remove a caught fish from the fishhook without heavily damaging the fish. It is however taught by Fujii that the sharp edges formed along the tip portion contact and tear off the pallet and flesh of the fish. It is further taught that such action decreases the squeezing resistance of the fishhook, which appears to be a principal object of the Fujii teaching.

Fujii states, although they do not illustrate, that if a rectangular cut edge is employed for the second press, a flat rear face of the barb is obtained. In every illustration, the second press is shown as being round in cross section when it is being employed to chip the barb. However, if it is meant that the cross section of the second press would be rectangular rather than round, then, as taught, the rear face of the barb would be flat. The intersection of such a flat rear face with the sharp edge of the barb, would form a point such that removal of the Fujii hook from the mouth of a fish would cause tearing and cutting damage, unless the point was aligned with tearing and cutting already incurred by the sharp edges of the barb. Thus although the Fujii hook may not cause the heavy damage that a conventionally spiked barb might, some damage is nonetheless caused by the Fujii hook and barb, described by Fujii as being a tearing of the pallet and flesh of the fish.

Fujii. illustrates in FIG. 20 the steps in producing a hook having a barb, or at least a hook having a protrusion which clearly is formed with a stress concentration causing corner 4 (seen in FIG. 20(e)) which would cause injury to a fish upon removal of the hook. The intermediate steps illustrated in FIGS. 20(b) and 20(c) are taught by Fujii to be intermediate, there being no suggestion that they form an end product. The fact that Fujii only teaches completing the hook formation steps of FIGS. 20(a)-20(e), thus instead of leading one to the hook of the present invention, teaches away. To follow the teaching of Fujii would result in always forming a sharp corner or protrusion in the manner of a barb. Further, the shape of the hook during the formation process of FIGS. 20(b) and 20(c) lacks the shape of the hook setting convexity of the present invention in that the slope of the hook in FIGS. 20(b) and 20(c) are symmetric on both the tip or point side and the shank side. This is contrary to the present invention in which the convexity has a slope on the tip or point side of the convexity which is a more gentle slope than the steeper or more drastic slope of the convexity on the shank side.

It might be observed, erroneously, that in the Fujii disclosure, specifically Fujii FIG. 21(b) (FIG. 10 herein), Fujii teaches a fish hook having a shank and spike that has a first slope, towards the point of the spike, and a second slope, at the shoulder of the spike, which has rounded surfaces and is steeper than the first slope to form a barbless fishing hook. What Fujii discloses in FIG. 21(b) is an intermediate form during the manufacturing process, not intended to be a fishing hook, but rather a form used in one step of the disclosed process of Fujii wherein barbs are chipped from the shoulder formed behind the spike.

Fujii illustrates in FIG. 25 (seen in FIG. 12 herein), and discusses as being prior art, a fish hook having a bulged barb formed at the inner side of the fish hook body instead of a sharp barb. The bulged barb is a symmetric bulge in the sense that the degree of slope of the forward dome of the bulge, extending from the vertex of the bulge towards the fish hook spike, has approximately the same degree of slope as the slope of the rearward dome of the bulge, extending from the vertex of the bulge towards the fish hook shank. It is not suggested by Fujii to produce the asymmetric, smoothly contoured barbless hooks having the convexity of the present invention. Straining to find such in the Fujii disclosure is to distort the teaching of Fujii who does not rely on an intermediate planform of a barb as providing any improvement or function as a barb per se, and who states that the prior art bulged barb makes it difficult to attach a bait to the fish hook because the bulged barb obstructs passage of the bait, from which it is apparent that Fujii considered the prior art bulged barb inferior as the thrust of the Fujii teaching is to reduce the squeezing resistance of the hook and barb passing through the palate of the mouth of the fish.

Thus, what is neither taught nor suggested in the prior art, and which it is an object of the present invention to provide, is to remove sharp edges entirely from the fishhook and merely to provide a smoothly rounded convexity be it teardrop-shaped, bulbous, or fin-shaped where a gently inclined slope between the spike and the top of the convexity allows for ease of setting of the hook, and a smoothly rounded wide-end of the convexity or truncation surface having a slope steeper than that of the gently inclined slope provides so-called “holding power” which resists the hook pulling back out the penetration wound until the convexity is “popped” through the hole. That is, were the slope of the truncation surface gently inclined in the manner of the inclined surface between the spike and the top of the fin, the hook would be removed from the penetration wound with the same ease with which the hook was set. This would not be a significant improvement over prior art barbless fishing hooks which, as described above, cause repeated stiletto wounding.

### SUMMARY OF THE INVENTION

In the barbless hook of the present invention, instead of the use of a barb, a convexity, be it teardrop-shaped (that is, in the way that a teardrop would look if sliding down the spike of the fish hook), bulbous, or a domed “fin” or “bulge” (collectively referred to as a convexity) is formed on the pointed spike portion of the fishing hook. The convexity has a longitudinally gently inclined leading surface extending between the spike on the hook and the apex of the convexity. A smoothly inclined rearmost or truncation surface on the wide-end of the convexity adjacent the curved shank blends the convexity with the shank of the hook. The rearmost surface of the convexity is inclined more steeply than the gently inclined leading surface.

In summary, the barbless fishing hook of the present invention includes a base shank portion, a tapered end portion having a pointed end at a distal end thereof, and a curved shank portion extending between the base shank portion and the tapered end portion. The tapered end portion has an inner side in opposed facing relation to the base shank portion, and an opposite outer side. A convexity is formed on the tapered end portion. The convexity has a gently inclined tapered leading surface and a contiguous smoothly inclined rear surface. The convexity is formed asymmetrically on either the inner side or the outer side of the tapered end portion. The convexity is oriented so that a thin end of the tapered leading surface points to the pointed end and the rear surface is adjacent the curved shank portion.

The rear surface is more steeply inclined relative to the tapered end than the tapered leading surface and does not form an undercut relative to the tapered end portion. The side of the tapered end portion opposite from the convexity is linear from the curved shank portion to the pointed end in a plane containing the point, the tapered end portion, the convexity and the base shank portion. In other words, the convexity forms an asymmetry on the tapered end portion relative to a longitudinal axis of the tapered end portion.

In the preferred embodiment, the convexity is generally of the shape of a teardrop on the tapered end portion, that is, the shape a teardrop would make if it had ran down the tapered end portion from the pointed end.

In a more specific description of the barbless fishing hook of the present invention, the tapered end portion has a longitudinal axis, the pointed end lying on the axis, and extending longitudinally along the tapered end portion. A radially expanded surface extends over the convexity. The radially expanded surface extends radially outwardly of the longitudinal axis so as to define, in a plane perpendicular to the longitudinal axis, a smoothly rounded generally radial arc devoid of stress concentration causing corners or elongate protrusions. It defines, in a second plane containing the longitudinal axis, along the intersection of the second plane with the radially expanded surface, a line of intersection smoothly blending the radially expanded surface with the tapered end portion adjacent the pointed end at one end of the line of intersection and with the curved shank portion at an opposite end of the line of intersection.

The distance between the line of intersection and the longitudinal axis, perpendicular to the longitudinal axis, increases smoothly, so as to define a first slope, along the tapered end portion from adjacent the pointed end to a maximum radial distance where the smoothly rounded generally radial arc sweeps out a maximum area contained in the plane perpendicular to the longitudinal axis.

A truncation surface is located adjacent the maximum area, on an opposite side of the plane containing the maximum area. The truncation surface smoothly rounds off the radially expanded surface so as to smoothly blend with the curved shank portion, without an undercut. The truncation surface has a second slope. The second slope is steeper than the first slope.

The first slope is smoothly and gently inclined so as to form an acute angle with the longitudinal axis adjacent the pointed end. The first slope extends between the pointed end and a domed apex on the convexity. The domed apex has a smoothly rounded surface extending between the first slope and the truncation surface. The truncation surface extends generally along the tapered end portion between the domed apex and the curved shank portion. The convexity has opposite first and second sides extending smoothly laterally radially outward of the longitudinal axis. The domed apex and the first and second sides may form a continuously smooth rounded surface.

The radially expanded surface may be a generally conical surface extending from adjacent the pointed end along the tapered end portion. The conical surface smoothly expands increasingly radially outward of the longitudinal axis until truncated at the truncation surface.

The convexity may also be described as forming, at a leading end thereof, generally the shape of a bisected truncated elliptical cone. The cone is truncated at its widest end and bisected along its longitudinal axis of symmetry. The convexity forms, at a contiguous rear end thereof, generally a bisected hemisphere. The hemisphere is bisected along its axis of symmetry, The bisected truncated elliptical cone smoothly contiguous with the bisected hemisphere at an intersection of a widest end of the bisected hemisphere and the widest end of the bisected truncated elliptical cone. Alternatively the convexity forms at the contiguous rear end, generally a second bisected truncated elliptical cone, bisected along its axis of symmetry. In this case the first bisected truncated elliptical cone is smoothly contiguous with the second bisected truncated elliptical cone at an intersection of a widest end of the second bisected truncated elliptical cone and the widest end of the first bisected truncated elliptical cone.

### BRIEF DESCRIPTION OF THE DRAWINGS

FIG. 1 is a prior art barbed fishing hook.

FIG. 2 is a prior art barbless fishing hook.

FIG. 3 is, in partial perspective view, one embodiment of the barbless fishing hook of the present invention.

FIG. 3a is, in partial, perspective view, the barbless fishing hook of the present invention.

FIG. 3b is the barbless hook of FIG. 3a illustrated in a wire-frame.

FIG. 4a is, in side elevation view, the barbless fishing hook of FIG. 3a.

FIG. 5a is the barbless fishing hook of FIG. 4a along line 5a-5a.

FIG. 6a shows in a side elevation view a barbless hook of the present invention in dotted outline striking tissue in a fish's mouth.

FIG. 6b is the view of FIG. 6a with the hook penetrating the tissue.

FIG. 6c is the view of FIG. 6b with the convexity of the hook setting the hook in the tissue.

FIG. 6d is the initial stretching of the tissue of FIG. 6a as the hook is withdrawn through the tissue.

FIG. 6e is the view of FIG. 6d with the convexity of the hook withdrawn through the penetration hole.

FIG. 7 is, in partial perspective view, the barbless fishing hook of FIG. 3a with the tapered portion of the hook shown in dotted outline and the convexity on the inside of the tapered portion.

FIG. 7a is, in partial perspective view, the barbless fishing hook of FIG. 3a with the tapered portion of the hook shown in dotted outline and the convexity on the outside of the tapered portion.

FIG. 7b is, in perspective view, the truncated bisected conical shape of the convexity of FIG. 7.

FIG. 7c is, in exploded perspective view, the bisected conical shape of FIG. 7b with a hemispherical truncation surface.

FIG. 7d is, in exploded perspective view, the bisected conical shape of FIG. 7b with a second bisected conical truncation surface.

FIGS. 8-13 are prior art fishing hooks and intermediate forms during the manufacturing thereof, and, specifically, FIGS. 8, 9, 10, 11, 12 and 13 are perspective views, FIGS. 8a, 9a, 10a and 11a are section views along lines 9a-9a, 10a-10a and 11a-11a in respectively, FIGS. 8, 9, 10 and 11.

FIG. 14 is a diagrammatic view of one method of manufacture of the barbless fishing hook of the present invention.

FIG. 15 is a diagrammatic view of an alternative method of manufacture of the barbless fishing hook of the present invention.

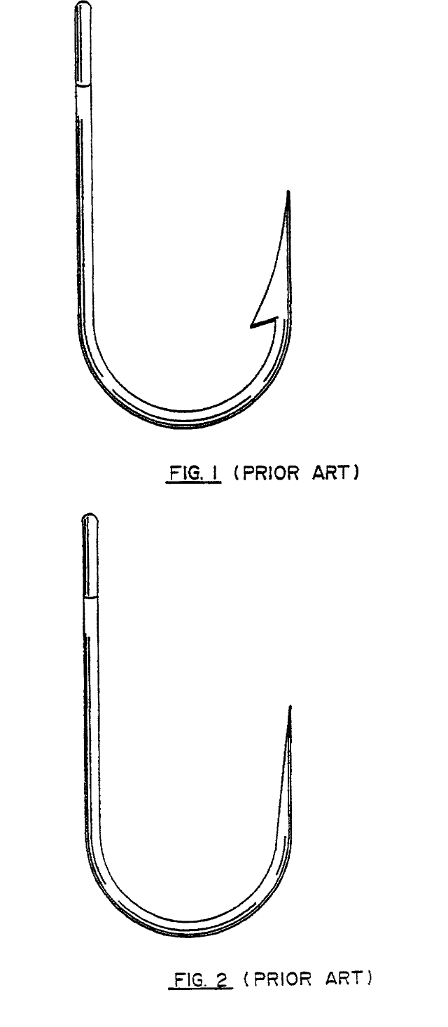

### DETAILED DESCRIPTION OF PREFERRED EMBODIMENTS

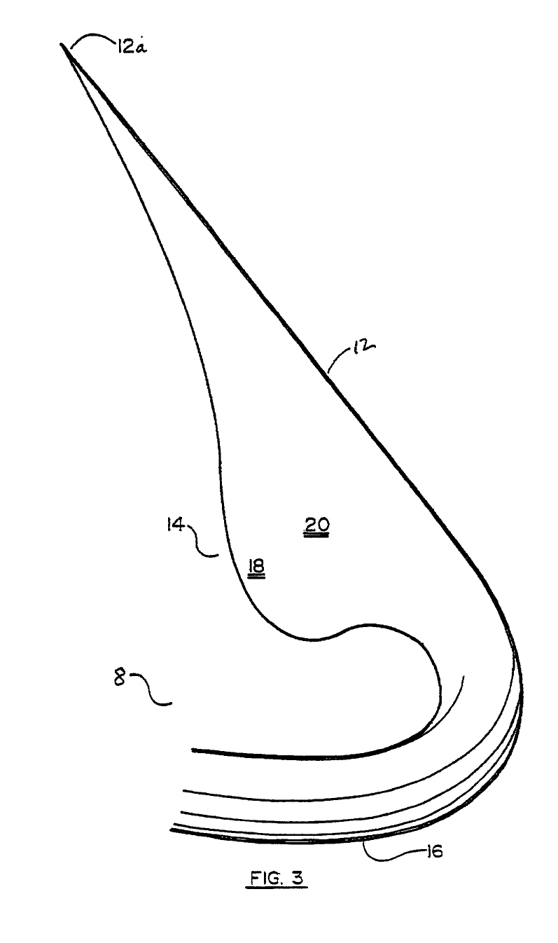

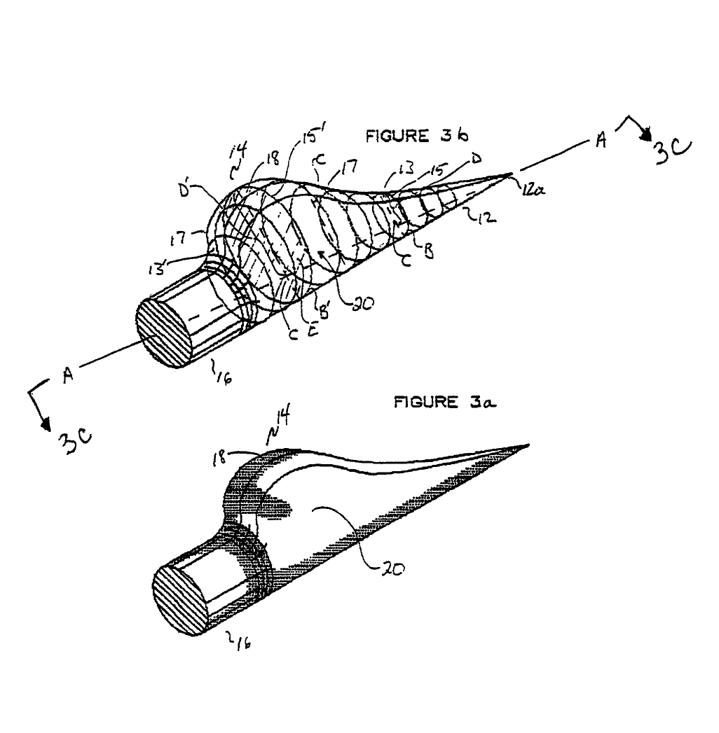

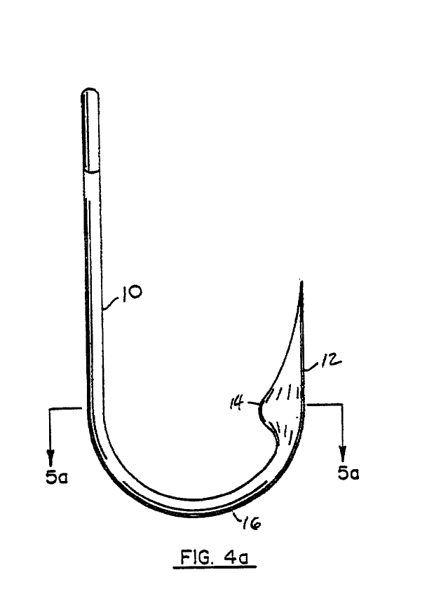

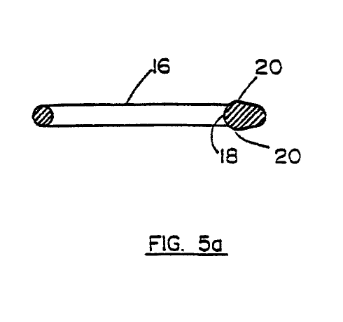

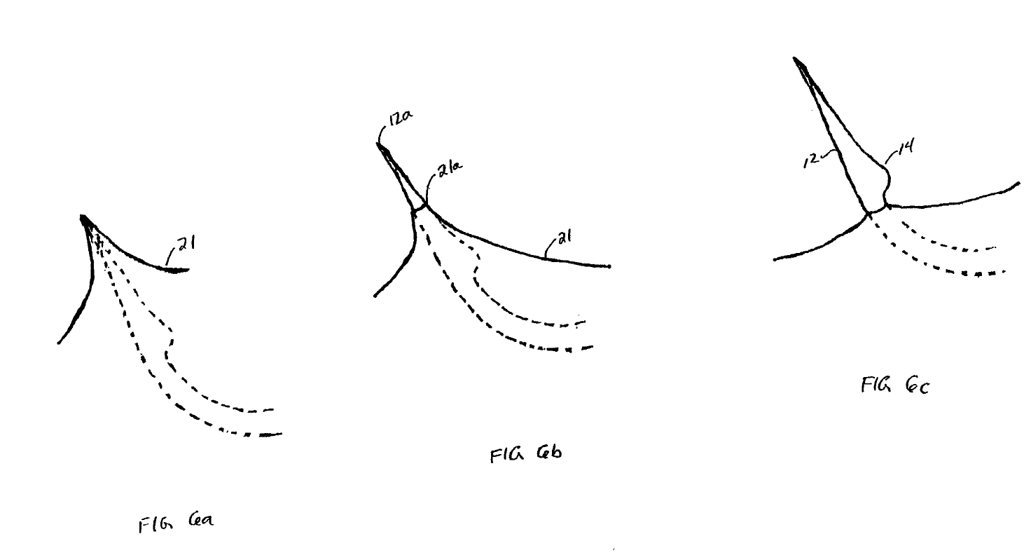

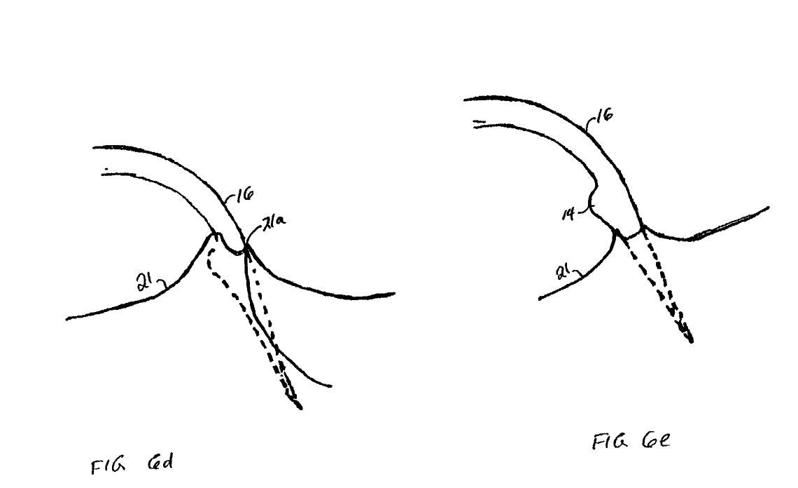

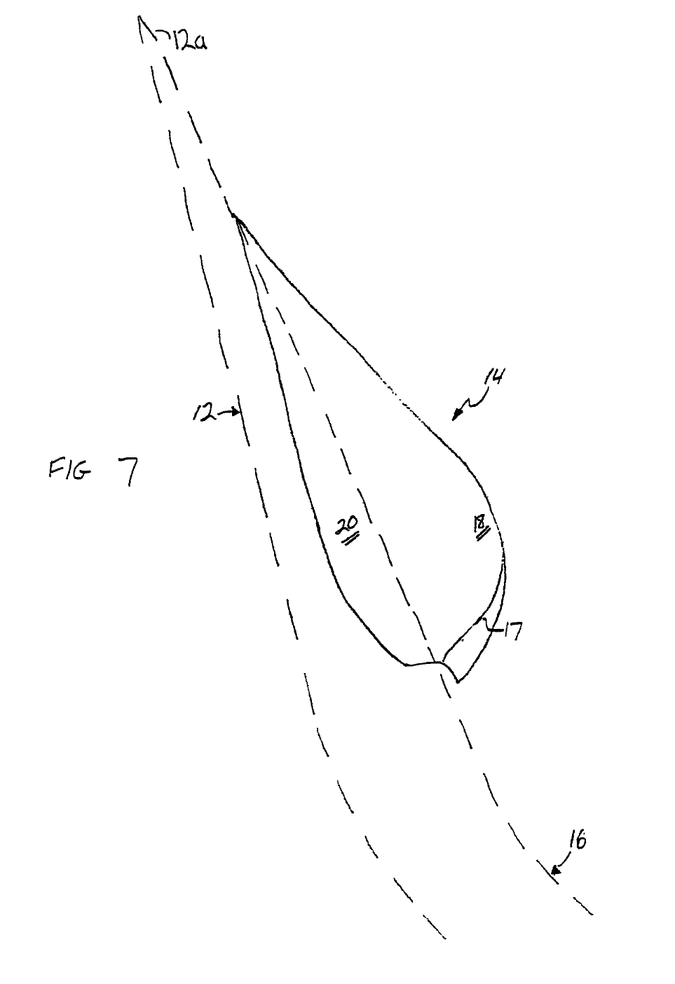

As depicted in FIGS. 3, 3a, 3b, 4a, 4b, 5a and 6, barbless fishing hook 8 has point or spike 12a on tapered portion 12, convexity 14 formed on an inner side of tapered portion 12, curved shank portion 16 and straight shank portion 10. Convexity 14 is a three dimensional surface including a domed apex 18. Convexity 14 includes convexly curved opposed sides 20. In the embodiment of FIGS. 4a and 5a, sides 20 and domed apex 18 are convexly curved generally about a centroid of convexity 14. The convexly curved sides 20 and domed apex 18 reduce stress concentrations in the soft tissue surrounding the penetration hole thereby minimizing the risk of a localized area of stress concentration which would cause tearing, and maximizing the length of the circumference of the convex surface, in other words, maximizing the volume of convexity 14 which as seen in FIGS. 6a-6e may be passed through puncture hole 21a in flesh 21 of the fish's mouth without causing tearing or causing inelastic deformation to thereby adversely affect the elastic hysteresis of the soft tissue around the puncture hole.

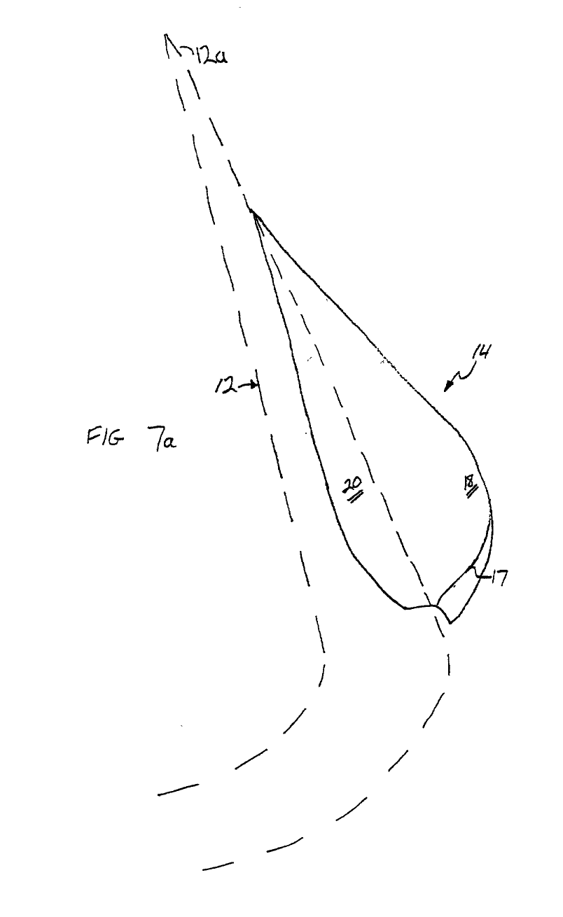

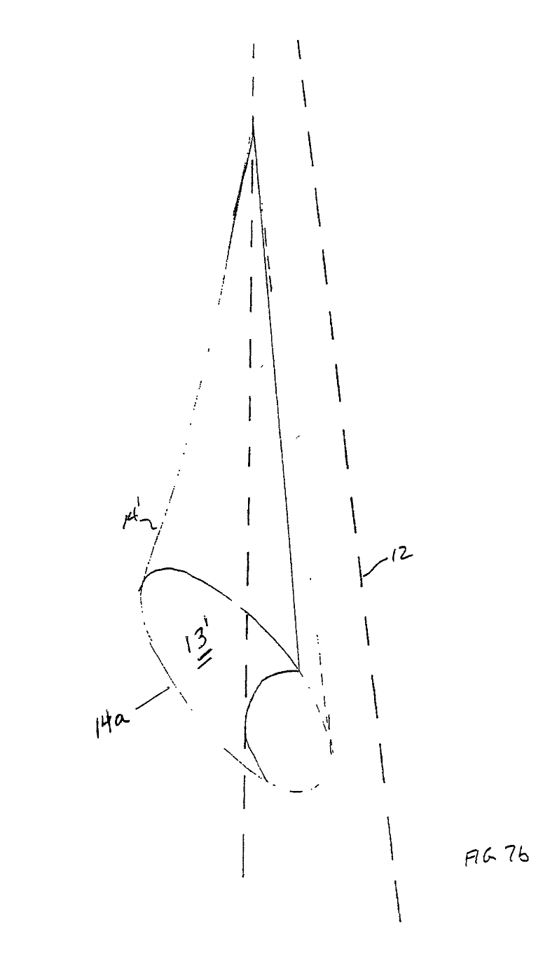

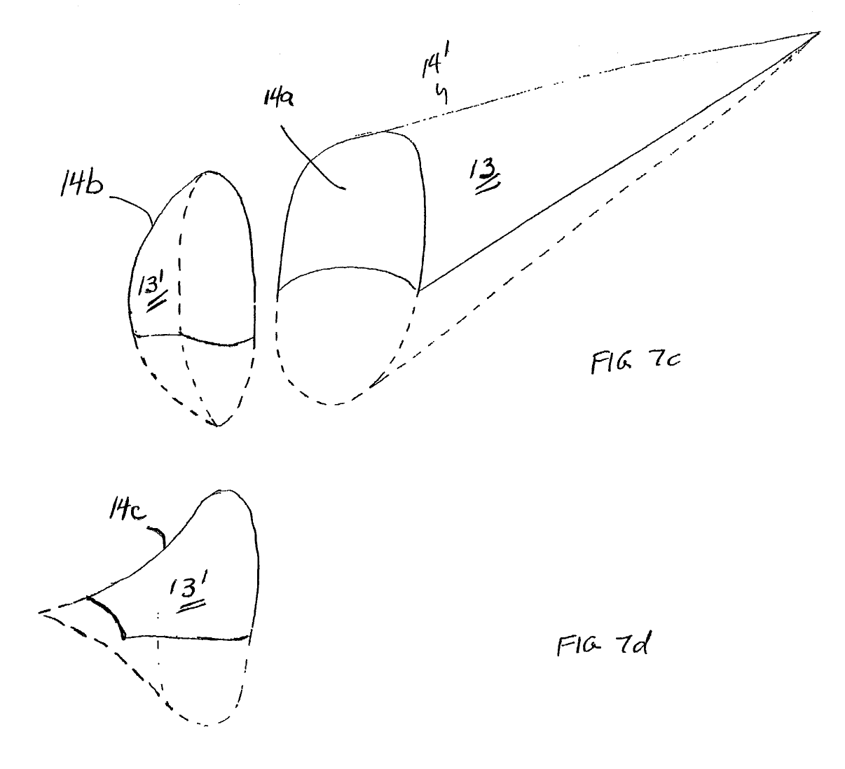

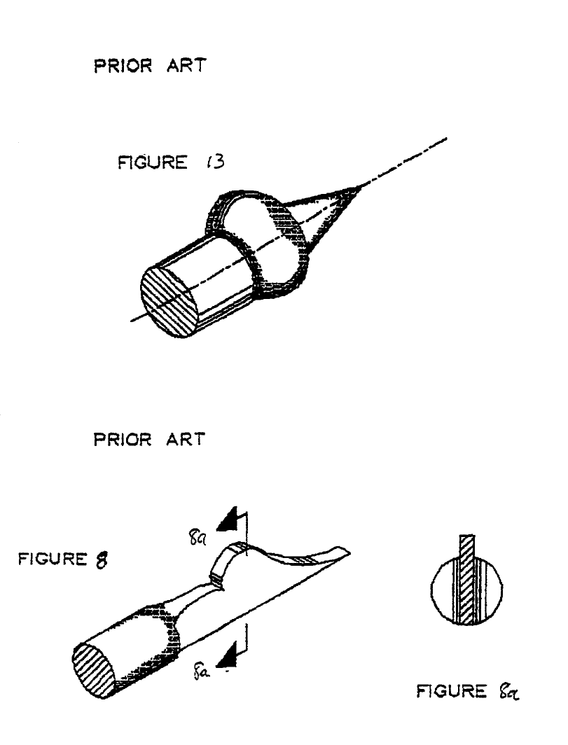

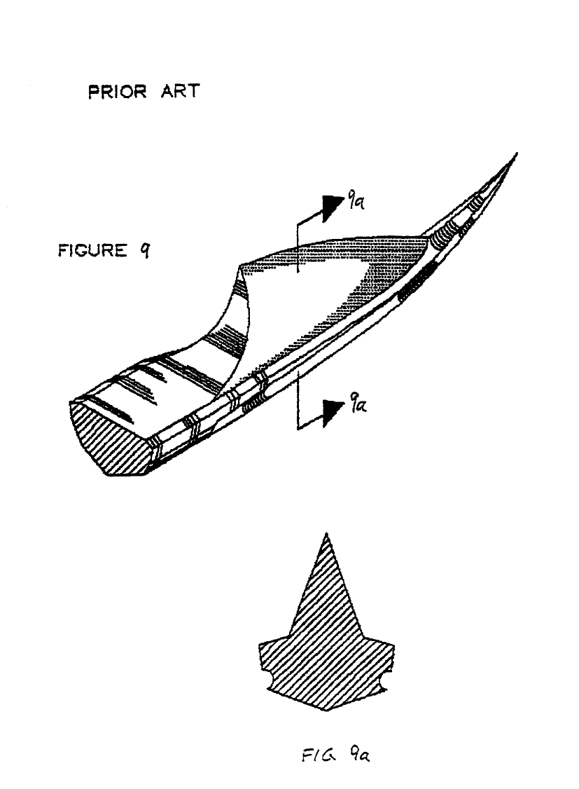

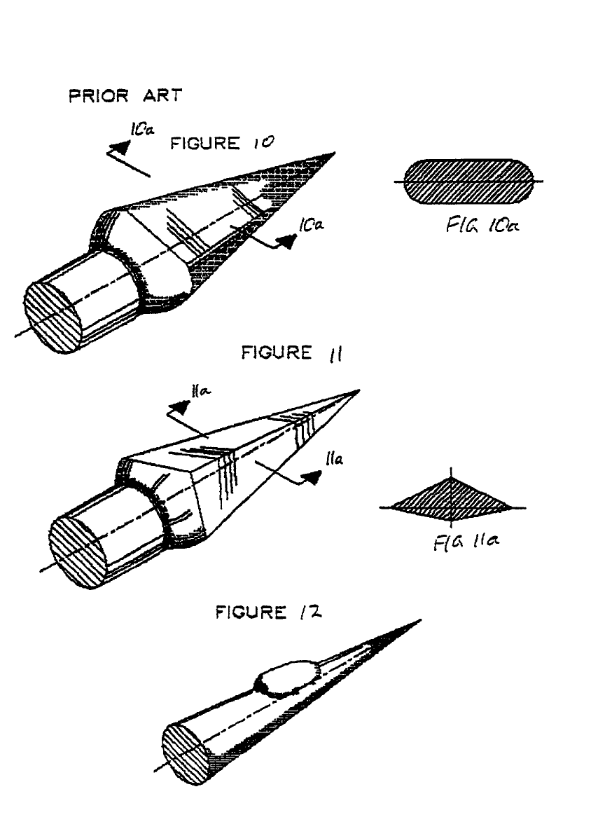

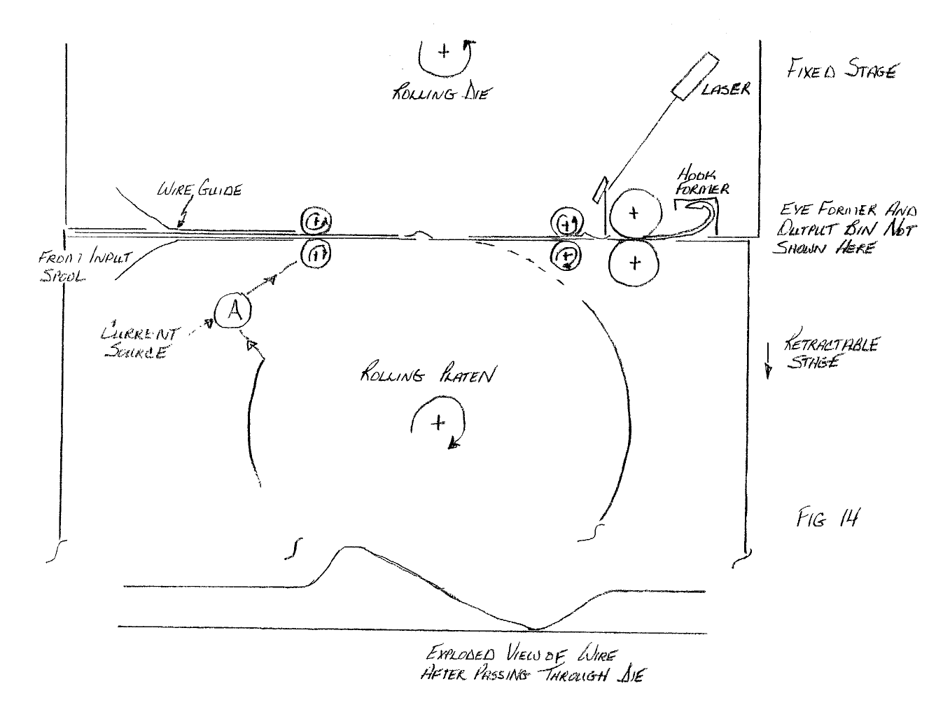

As seen in FIG. 7a, convexity 14 may also be formed asymmetrically on the outer surface of tapered portion 12. As seen in FIG. 7b, convexity 14 may be thought of as shaped like a truncated cone bisected along its long axis, truncated generally laterally relative to tapered portion 12 at the rear or widest end of convexity 14. As seen in FIGS. 7c and 7d, the truncated cone of FIG. 7b may be thought of as rounded at its widest end (forming what is also referred to herein as the truncation surface) by the patching of a bisected hemisphere (FIG. 7e) or by the patching of a second bisected truncated cone onto the truncation cone of FIG. 7b, where the dotted outlines in FIGS. 7c and 7d indicated the generally bisected portions thought of as cut-away when convexity 14 is formed in tapered end 12. In FIG. 7b the dotted outline is of tapered end 12, as in FIGS. 7 and 7a.

Tapered portion 12 has a longitudinal axis A. Spike 12a lies on the axis. A radially expanded surface 13 extends radially outwardly on one side of longitudinal axis A so as to define, in a plane B perpendicular to longitudinal axis A, a smoothly rounded generally radial arc 15 devoid of stress concentration causing corners or elongate protrusions and so as to define, in a second plane C containing longitudinal axis A, along the intersection of the second plane C with the radially expanded surface 13, a line of intersection 17 smoothly blending the radially expanded surface 13 with the adjacent curved shank 16 at one end of line of intersection 17 and with spike 12a at the opposite end of line of intersection 17. Plane B is illustrated as an array of parallel cross sections, in dotted outline, but understood to represent any plane parallel to those cross sections along tapered portion 12. The distance D between line of intersection 17 and longitudinal axis A, where distance D is perpendicular to longitudinal axis A, increases smoothly along portion 12 from spike 12a to a maximum radial distance D′ at a maximum radial distance position D″, where the smoothly rounded generally radial arc 15′ sweeps out a maximum area E in plane B′. Truncation surface 13′ adjacent domed apex 18 then smoothly rounds off radially inward from domed apex 18 to merge truncation surface 13′ with curved shank portion 16, without creating, in the manner of a barb, an undercut under convexity 14. As may be seen most clearly in FIGS. 3-7, the slope of truncation surface 13′ is steeper than the slope defined by line of intersection 17 along expanded radial surface 13 between spike 12a and plane B′.

It has been found that because of the elastically resilient nature of the soft tissue or flesh 21 of a fish's mouth, that an appropriately sized convexity 14 formed on the inner side of tapered portion 12 will have the following benefits:

a) upon initial strike, flesh 21 stretches as seen exaggerated in FIG. 6a, then upon penetration of spike 12a through flesh 21 so as to form hole 21a as seen in FIG. 6b, the gently inclined leading surface of convexity 14 merely resiliently stretches open hole 21a allowing entry of convexity 14 through penetration hole 21a without tearing of the tissue,

b) once the leading surface of the convexity has passed through penetration hole 21a, the rounded apex 18 and inclined rearward surface allows the tissue of the fish's mouth to close in an elastically resilient fashion around the shaft of the hook as seen in FIG. 6c, the rounded smooth domed surface of the apex of the convexity allowing a larger convexity by volume without tearing the tissue to allow more effective setting of the hook.

Because the tissue does not tear, but rather remains as small penetration hole 21a, the rearward surface acts to anchor the convexity (and consequently the entire hook) within flesh 21 of the fish's mouth much as in the manner of a conventional barbed hook.

When it is desired to remove the hook from the fish's mouth, again without tearing the tissue of the fish's mouth, the fact that the rearward surface is not vertical but is smoothly inclined (albeit at a greater angle relative to axis A than the leading surface) combined with the rounding of the apex of the convexity, allows for the convexity and hook to be “popped”, i.e. released by initially elastically re-stretching open the penetration hole in the tissue of the fish's mouth as seen in FIG. 6d, and then popping the flap of tissue 21b caught on convexity 14 over the convexity so as to withdraw the hook from the penetration hole as seen in FIG. 6e without tearing of the tissue of the fish's mouth.

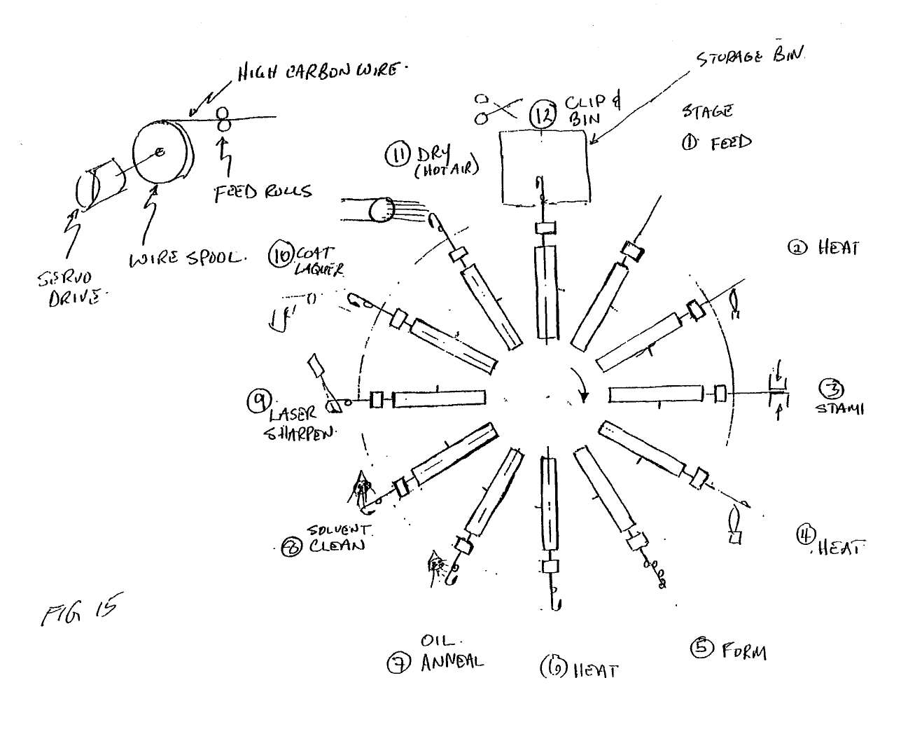

The barbless hook may in one method be manufactured as seen in FIG. 14 by continuous die cast or rolling die method where by the wire is guided from the input spool through a series of guides and rolls. The wire may be preheated while on the spool, and is additionally heated using a high current between the input drive rolls and the rolling platen and optionally the rolling platen. The wire is heated to such a temperature that it becomes malleable enough for the die casting process. Both the rolling die and platen are machined to accommodate and guide the wire as it passes through, with the die machined to form the barbless bulb in the wire.

After the die casting process the hook blank is cut from the wire and sharpened using an industrial laser. The hook blank is retained by one or more sets of drive rolls that force it into a former shaping it into a J-shape. Finally the eye is applied to the tail end of the blank completing the hook.

The barbless hook may also be manufactured as seen in FIG. 15 by the following 12 step staged process:

1) Feed out enough wire to make a hook without cutting it off.

2) Heat the wire so that the tip of it becomes malleable.

3) Stamp the end of the wire to form the barbless bump and put a point on the end.

4) Heat the wire so that it is malleable for forming.

5) Form the eye and J of the hook in the wire.

6) Heat the wire hook for annealing.

7) Anneal/quench the wire hook to harden.

8) Clean the wire hook for lacquer coat.

9) Laser sharpen the wire hook tip.

10) Coat hook with lacquer.

11) Blow dry to accelerate lacquer curing.

12) Clip finished hook from wire and store finished product in bin or on a conveying mechanism.

Repeat.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A barbless fishing hook comprising:
a base shank portion, a tapered end portion having a pointed end at a distal end thereof, and a curved shank portion extending between said base shank portion and said tapered end portion,
said tapered end portion having an inner side in opposed facing relation to said base shank portion and an opposite outer side,
a convexity having a gently inclined tapered leading surface and a contiguous smoothly inclined rear surface, said convexity formed on only said inner side of said tapered end portion, wherein a thin end of said tapered leading surface points to said pointed end and said rear surface is adjacent said curved shank portion,
and wherein said rear surface is more steeply inclined relative to said tapered end than said tapered leading surface,
and wherein said outer side of said tapered end portion is linear from said curved shank portion to said pointed end in a plane containing said point, said tapered end portion, said convexity and said base shank portion, so that said convexity forms an asymmetry on said tapered end portion relative to a longitudinal axis of said tapered end portion,
and wherein said rear surface of said convexity does not form an undercut relative to said tapered end portion.

2. The barbless fishing hook of claim 1 wherein said convexity is of the shape of a teardrop on said tapered end portion.

3. A barbless fishing hook of claim 1 wherein said tapered end portion has
a longitudinal axis, said pointed end lying on said axis, and extending longitudinally along said tapered end portion, a radially expanded surface over said convexity, said radially expanded surface extending radially outwardly of said longitudinal axis so as to define, in a first plane perpendicular to said longitudinal axis, a smoothly rounded radial arc devoid of stress concentration causing corners or elongate protrusions and so as to define, in a second plane containing said longitudinal axis, along the intersection of said second plane with said radially expanded surface, a line of intersection smoothly blending said radially expanded surface with said tapered end portion adjacent said pointed end at one end of said line of intersection and with said curved shank portion at an opposite end of said line of intersection and said distance between said line of intersection and said longitudinal axis, perpendicular to said longitudinal axis, increasing smoothly, so as to define a first slope, along said tapered end portion from adjacent said pointed end to a maximum radial distance where said smoothly rounded generally radial arc sweeps out a maximum area contained in said first plane, a truncation surface adjacent said maximum area, on an opposite side of said first plane containing said maximum area said truncation surface smoothly rounding off said radially expanded surface so as to smoothly blend with said curved shank portion, without an undercut, said truncation surface having a second slope, said second slope steeper than said first slope.

4. The barbless fishing hook of claim 3 wherein said first slope is smoothly and gently inclined so as to form an acute angle with said longitudinal axis adjacent said pointed end, said first slope extending between said pointed end and a domed apex on said convexity wherein said domed apex has a smoothly rounded surface extending between said first slope and said truncation surface, said truncation surface extending along said tapered end portion between said domed apex and said curved shank portion, and wherein said convexity has opposite first and second sides extending smoothly laterally radially outward of said longitudinal axis.

5. The barbless fishing hook of claim 4 wherein said domed apex and said first and second sides form a continuously smooth rounded surface.

6. The barbless fishing hook of claim 3 wherein said radially expanded surface is a conical surface extending from adjacent said pointed end, along said tapered end portion, said conical surface smoothly expanding increasingly radially outward of said longitudinal axis, said conical surface truncated at said truncation surface.

7. The barbless fishing hook of claim 1 wherein said convexity forms at a leading end thereof the shape of a bisected truncated elliptical cone, truncated at its widest end and bisected along its longitudinal axis of symmetry, and forms at a contiguous rear end thereof a bisected hemisphere, bisected along its axis of symmetry, said bisected truncated elliptical cone smoothly contiguous with said bisected hemisphere at an intersection of a widest end of said bisected hemisphere and said widest end of said bisected truncated elliptical cone.

8. The barbless fishing hook of claim 1 wherein said convexity forms at a leading end thereof generally the shape of a first bisected truncated elliptical cone, truncated at its widest end and bisected along its longitudinal axis, and forms at a contiguous rear end thereof a second bisected truncated elliptical cone, bisected along its axis of symmetry, said first bisected truncated elliptical cone smoothly contiguous with said second bisected truncated elliptical cone at an intersection of a widest end of said second bisected truncated elliptical cone and said widest end of said first bisected truncated elliptical cone.

9. A barbless fishing hook comprising:
a base shank portion, a tapered end portion having a pointed end at a distal end thereof, and a curved shank portion extending between said base shank portion and said tapered end portion,
said tapered end portion having an inner side in opposed facing relation to said base shank portion and an opposite outer side,
a convexity having a gently inclined tapered leading surface and a contiguous smoothly inclined rear surface, said convexity formed on only said outer side of said tapered end portion, wherein a thin end of said tapered leading surface points to said pointed end and said rear surface is adjacent said curved shank portion,
and wherein said rear surface is more steeply inclined relative to said tapered end than said tapered leading surface,
and wherein said inner side of said tapered end portion is linear from said curved shank portion to said pointed end in a plane containing said point, said tapered end portion, said convexity and said base shank portion, so that said convexity forms an asymmetry on said tapered end portion relative to a longitudinal axis of said tapered end portion,
and wherein said rear surface of said convexity does not form an undercut relative to said tapered end portion.

10. The barbless fishing hook of claim 9 wherein said convexity is of the shape of a teardrop on said tapered end portion.

11. A barbless fishing hook of claim 9 wherein said tapered end portion has
a longitudinal axis, said pointed end lying on said axis, and extending longitudinally along said tapered end portion, a radially expanded surface over said convexity, said radially expanded surface extending radially outwardly of said longitudinal axis so as to define, in a first plane perpendicular to said longitudinal axis, a smoothly rounded radial arc devoid of stress concentration causing corners or elongate protrusions and so as to define, in a second plane containing said longitudinal axis, along the intersection of said second plane with said radially expanded surface, a line of intersection smoothly blending said radially expanded surface with said tapered end portion adjacent said pointed end at one end of said line of intersection and with said curved shank portion at an opposite end of said line of intersection and said distance between said line of intersection and said longitudinal axis, perpendicular to said longitudinal axis, increasing smoothly, so as to define a first slope, along said tapered end portion from adjacent said pointed end to a maximum radial distance where said smoothly rounded generally radial arc sweeps out a maximum area contained in said first plane, a truncation surface adjacent said maximum area, on an opposite side of said first plane containing said maximum area, said truncation surface smoothly rounding off said radially expanded surface so as to smoothly blend with said curved shank portion, without an undercut, said truncation surface having a second slope, said second slope steeper than said first slope.

12. The barbless fishing hook of claim 11 wherein said first slope is smoothly and gently inclined so as to form an acute angle with said longitudinal axis adjacent said pointed end, said first slope extending between said pointed end and a domed apex on said convexity wherein said domed apex has a smoothly rounded surface extending between said first slope and said truncation surface, said truncation surface extending along said tapered end portion between said domed apex and said curved shank portion, and wherein said convexity has opposite first and second sides extending smoothly laterally radially outward of said longitudinal axis.

13. The barbless fishing hook of claim 12 wherein said domed apex and said first and second sides form a continuously smooth rounded surface.

14. The barbless fishing hook of claim 11 wherein said radially expanded surface is a conical surface extending from adjacent said pointed end, along said tapered end portion, said conical surface smoothly expanding increasingly radially outward of said longitudinal axis, said conical surface truncated at said truncation surface.

15. The barbless fishing hook of claim 9 wherein said convexity forms at a leading end thereof the shape of a bisected truncated elliptical cone, truncated at its widest end and bisected along its longitudinal axis of symmetry, and forms at a contiguous rear end thereof a bisected hemisphere, bisected along its axis of symmetry, said bisected truncated elliptical cone smoothly contiguous with said bisected hemisphere at an intersection of a widest end of said bisected hemisphere and said widest end of said bisected truncated elliptical cone.

16. The barbless fishing hook of claim 15 wherein said convexity forms at a leading end thereof generally the shape of a first bisected truncated elliptical cone, truncated at its widest end and bisected along its longitudinal axis, and forms at a contiguous rear end thereof generally a second bisected truncated elliptical cone, bisected along its axis of symmetry, said first bisected truncated elliptical cone smoothly contiguous with said second bisected truncated elliptical cone at an intersection of a widest end of said second bisected truncated elliptical cone and said widest end of said first bisected truncated elliptical cone.

17. A barbless fishing hook comprising:
a base shank portion, a tapered end portion having a pointed end at a distal end thereof, and a curved shank portion extending between said base shank portion and said tapered end portion,
a convexity having a gently inclined tapered leading surface and a contiguous smoothly inclined rear surface, said convexity formed on only one side of said tapered end portion, wherein a thin end of said tapered leading surface points to said pointed end and said rear surface is adjacent said curved shank portion,
and wherein said rear surface is more steeply inclined relative to said tapered end than said tapered leading surface,
and wherein a side opposite said only one side of said tapered end portion is linear from said curved shank portion to said pointed end in a plane containing said point, said tapered end portion, and said convexity, so that said convexity forms an asymmetry on said tapered end portion relative to a longitudinal axis of said tapered end portion,
and wherein said rear surface of said convexity does not form an undercut relative to said tapered end portion.

18. The barbless fishing hook of claim 9 wherein said convexity is teardrop shaped on said tapered end portion.

19. A fishhook comprising:
an apertured eye;
an integral elongated shank having an elongated axis terminating in an integral return bend portion,
a spear portion integral with the bend portion having a longitudinal axis generally parallel to the elongated as of said shank, said spear portion being rounded in cross sections;
a barb, integral with said spear portion adjacent and generally parallel to said shank and facing the same said barb terminating in a sharpened point;
said barb having a pre-barb section having a surface extending upwardly in a direction normal to the longitudinal axis of said spear portion, said surface being integrally formed with said spear portion at a first end and integrally formed with a rounded barb section at a second end, said rounded barb section.
